(19) United States
(12) Patent Application Publication
(10) Pub. No.: US 2005/0096768 A1
(43) Pub. Date: May 5, 2005

(54) System and method for formulating and redacting bending procedures used in manufacturing

(76) Inventors: Kuo Jung Huang, Tu-Chen (TW); Chung-Shao Cheng, Tu-Chen (TW); Feng-Ping Tsai, Tu-Chen (TW); Zejun Dai, Shenzhen (CN); Wei Shao, Shenzhen (CN); Qi-Guo Tao, Shenzhen (CN); Xiaobing Gao, Shenzhen (CN); Yang Hu, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/975,152

(22) Filed: Oct. 27, 2004

(30) Foreign Application Priority Data
Oct. 31, 2003 (TW) 92130555

(51) Int. Cl. G06F 19/00

(52) U.S. Cl. 700/97; 700/165

(57) ABSTRACT

A system for formulating and redacting bending procedures used in manufacturing includes an application server (12), designing computers (10), a corporation website (13), a local database (16), and a production management system database (17). The application server is for generating guidance documents for bending machine operations. The designing computer is for providing a user interface for users. The corporation website is for providing an operation platform for formulating and redacting bending procedures. The local database is for storing information on bending procedures. The production management system database is for storing tool lists and bending tool information. A related method is also disclosed.

### BACKGROUND OF THE INVENTION

1. Field of the Invention

The present invention relates to systems and methods for formulating bending procedures used in manufacturing products, and particularly to a system and method for formulating bending procedures which can generate guidance documents for operations of bending machines.

2. Background of the Invention

Bending operations play an important role in forming products from sheet metal. Correct guidance for workers who perform bending operations is crucial for product quality, therefore high standard bending procedures are becoming increasingly important. An integrated, coherent bending procedure can help bending machine operators to clearly and quickly master information on bending operations such as bending sequences and dimension standards. The integrated bending procedure not only improves the efficiency of the bending operations, but also affirms the accuracies of the bending procedures.

Many bending operations are accomplished merely by accumulated experience of bending machine operators, not by integrated and systematic guidance documents. Systems for formulating and redacting bending procedures are disclosed in a number of patents such as Taiwan Pat. No. 537937 issued on Jul. 21, 2003 and entitled “Metallic Sheet Bending Apparatus With Anti-elasticity Limitation.” This patent discloses an apparatus for limiting metallic anti-elasticity in order to bend metallic sheets. The desired configuration after bending of the metallic sheets may be U-shaped. However, the apparatus is not guided by standard operation documents, which can lead to inaccuracies in the bending operations. Thus, a system and method for formulating and redacting bending procedures used in manufacturing which overcomes the above-mentioned problems is desired.

### SUMMARY OF THE INVENTION

Accordingly, a main objective of the present invention is to provide a system and method for formulating and redacting bending procedures used in manufacturing which generates various kinds of bending procedure guidance documents for use in bending machine operations.

To accomplish the above objective, a system in accordance with a preferred embodiment of the present invention for formulating and redacting bending procedures used in manufacturing comprises an application server, a plurality of designing computers, and a local database. The application server comprises a plurality of function modules for inputting parameters for bending procedures through the designing computers. The application server comprises: a collision simulating module, a parameter setting module, a manufacturing information card generating module, a tool list generating module, an SOP (Standard Operating Procedure) document generating module, a schematic tool manipulation diagram generating module, and a schematic shaping diagram generating module. The collision simulating module is for simulating collisions according to product engineering diagrams, and provides guidance for selecting correct and reasonable bending tools. The parameter setting module is for receiving all kinds of bending procedure parameters. The bending procedure parameters include bending sequences, working procedures, machining attributes, bending angles and bending machines, L values, D values, and so on. The bending sequences are successive steps for bending a product in a bending machine. The bending sequences belong to a working procedure. The working procedures are processing steps of a bending machine during a product's machining. An L value is a parameter for controlling a bending length. A D value is a parameter for controlling a bending angle. The manufacturing information card generating module is for generating manufacturing information cards on a bending procedure, according to a preset bending procedure parameter. The tool list generating module is for generating all kinds of tool lists for a bending process. The tool list records bending tools' names, lengths, and quantities. The SOP document generating module is for generating SOP documents. The SOP documents comprise standard bending operations, and are for guiding bending machine operators to perform bending operations. The tool manipulation diagram generating module is for generating tool manipulation diagrams and tool manipulation methods for bending machine operators. The shaping diagram generating module is for generating shaping diagrams. The shaping diagrams show information on bending directions and lengths.

Further, the present invention provides a method for formulating and redacting bending procedures used in manufacturing, comprising the steps of: setting bending sequences; setting working procedures including machining attributes, bending angles, and bending machines; generating one or more manufacturing information cards on bending machine operations according to the bending sequences and the working procedures; generating one or more tool lists according to the bending sequences and the working procedures; generating one or more SOP documents according to the bending sequences and the working procedures; generating one or more tool manipulation diagrams according to the bending sequences and the working procedures; and generating one or more shaping diagrams according to the bending sequences and the working procedures.

Other objects, advantages and novel features of the present invention will be drawn from the following detailed description with referred to the attached drawings, in which:

### BRIEF DESCRIPTION OF THE DRAWINGS

FIG. 1 is a schematic diagram of hardware infrastructure of a system in accordance with the preferred embodiment of the present invention for formulating and redacting bending procedures used in manufacturing;

FIG. 2 is a schematic diagram of main function modules of an application server of the system of FIG. 1; and

FIG. 3 is a flowchart of a preferred method for implementing the system of FIG. 1.

### DETAILED DESCRIPTION OF THE INVENTION

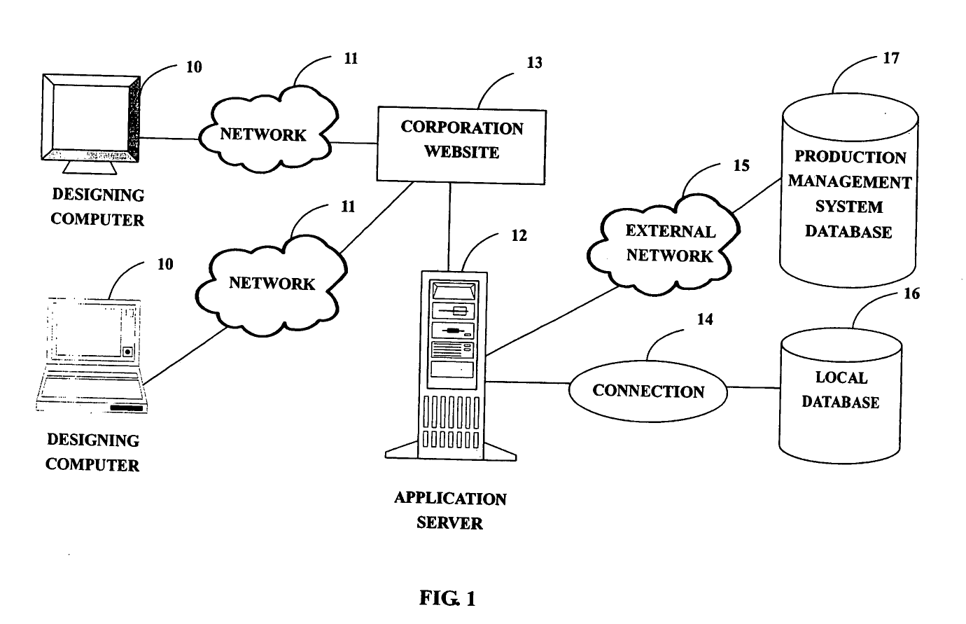

FIG. 1 is a schematic diagram of hardware infrastructure of a system in accordance with the preferred embodiment of the present invention for formulating and redacting bending procedures used in manufacturing (hereinafter, “the system”). The system comprises a plurality of designing computers 10, an application server 12, and a local database 16. The application server 12 comprises a plurality of function modules for inputting bending procedure parameters and generating bending procedure guidance documents. The guidance documents are specifications for bending machine operations. The guidance documents include manufacturing information cards on bending procedures, tool lists, schematic shaping diagrams, SOP (Standard Operating Procedure) documents, and schematic tool manipulation diagrams. The manufacturing information cards are guidance documents for ensuring each product's integrity during its manufacturing, and are used by bending machine operators. The manufacturing information cards include information on a product. The information includes working procedures, bending tools, assignments of working procedures to various operators, and so on. The tool list shows information on all bending tools needed in each working procedure. The information includes bending tools' names, numbers, lengths, and quantities. Each shaping diagram is part of a corresponding SOP document. The shaping diagram generally only includes a plan view and a cross-sectional view of a metallic sheet to be bent. The shaping diagram clearly and accurately shows information on bending directions and lengths. Each SOP document is a standard guide for bending machine operations, and is used for guiding bending machine operators to perform bending operations. The tool manipulation diagrams are guidance documents showing specific methods for setting up and using tools. The tool manipulation diagrams show information on bending tools such as length, station, and so on. That is, the bending tools are dies. The designing computers 10 may be desktop computers or notebook computers.

Each designing computer 10 is connected to a corporation website 13 through a network 11, and provides an interactive user interface for users to set bending procedure parameters. The network 11 may be any suitable communication architecture required by the system, such as an intranet or the Internet. The corporation website 13 is connected to the application server 12, and provides an operation platform for formulating and redacting bending procedures. The application server 12 is connected to the local database 16 through a connection 14. The connection 14 is database connectivity such as ODBC (Open Database Connectivity) or JDBC (Java Database Connectivity). The application server 12 is connected to a production management system database 17 through an external network 15, which may for example be the Internet. The production management system database 17 stores tool lists and bending tool information. The bending tool information includes bending tools' names, types, applicable bending machines, sizing specifications, and so on. The local database 16 stores information used and generated in the above-described processes.

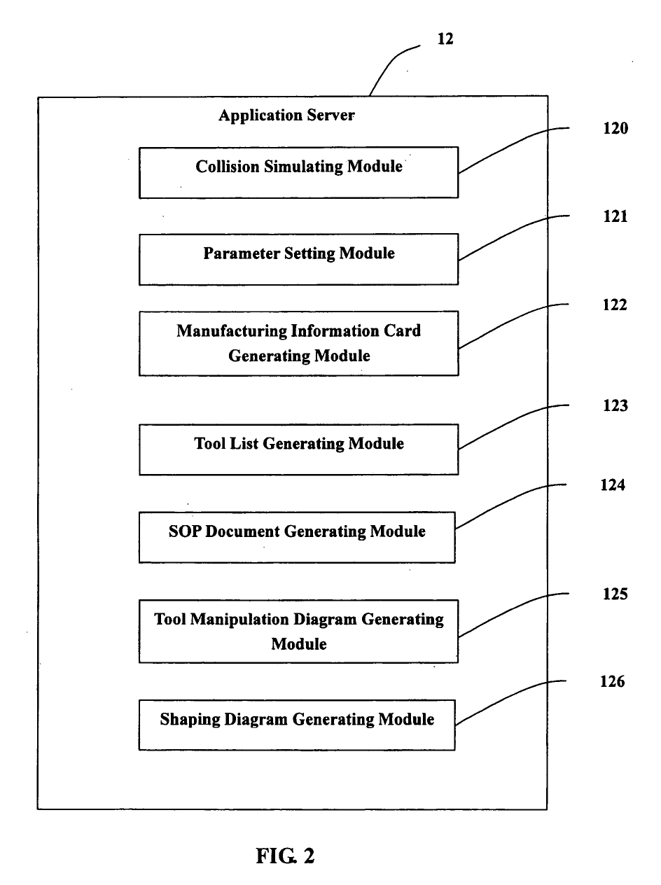

FIG. 2 is a schematic diagram of main function modules of the application server 12. The application server 12 comprises a collision simulating module 120, a parameter setting module 121, a manufacturing information card generating module 122, a tool list generating module 123, an SOP document generating module 124, a tool manipulation diagram generating module 125, and a shaping diagram generating module 126.

The collision simulating module 120 simulates collisions according to product engineering diagrams. The simulated collisions help anticipate and prevent manufacturing difficulties, and provide support for selecting correct and reasonable bending tools.

The parameter setting module 121 receives bending procedure parameters. The bending procedure parameters include bending sequences, working procedures, machining attributes, bending angles, bending machines, L values, D values, and so on. The bending sequences are successive steps for bending a product in a bending machine. The bending sequences belong to a working procedure. The working procedures are processing steps of a bending machine during a product's machining. An L value is a parameter for controlling a bending length. A D value is a parameter for controlling a bending angle.

The manufacturing information card generating module 122 generates manufacturing information cards on bending procedures, according to preset bending procedure parameters. Each manufacturing information card provides guidance for ensuring a product's integrity when the product is operated upon by bending machine operators.

The tool list generating module 123 generates tool lists needed for bending processes. Each tool list includes bending tools' names, numbers, lengths, and quantities. The tool list generating module 123 sets a master tool list to record information on bending tools which are usually used. When accessing the production management system database 17, the tool list generating module 123 compares the master tool list with information on bending tools needed for a particular working procedure. If the master tool list matches the bending tools needed for the working procedure, the tool list generating module 123 generates and stores a copy of the master tool list accordingly. If the master tool list is deficient, the tool list generating module 123 adds information on other bending tools that are needed for the working procedure to the tool list, and then generates and stores a new tool list accordingly. If the master tool list contains surplus bending tools, the tool list generating module 123 deletes the surplus bending tools that are not needed for the working procedure from the tool list, and then generates and stores a new tool list accordingly.

The SOP document generating module 124 generates SOP documents. Each SOP document is a guide for standard bending machine operations, and is used for guiding bending machine operators to perform bending operations.

The tool manipulation diagram generating module 125 generates tool manipulation diagrams. The tool manipulation diagram generating module sets an outline length and height of each tool manipulation diagram, together with a schematic scale and a die's coordinates. The tool manipulation diagram generating module 125 provides specific methods for setting up and using tools, for reference by bending machine operators. Each method includes a die's length, station, and so on.

The shaping diagram generating module 126 generates shaping diagrams. Each shaping diagram shows information on a product's bending directions and lengths.

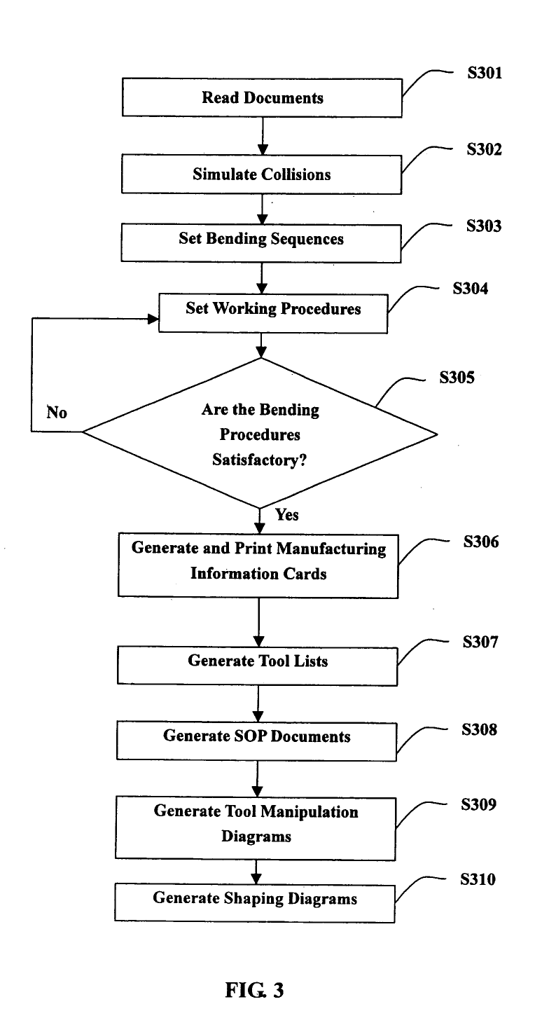

FIG. 3 is a flowchart of a preferred method for implementing the system. In step S301, the application server 12 reads a document from the local database 16. For example, the document may be a new engineering document which describes a workpiece that is to bent. If so, the document includes the workpiece's planforms, shaping diagrams, design requirements, dimension notes, notice of specifications, and an outline of a tool manipulation diagram. In another example, the document may be an old engineering document which contains bending data on a processed product. In step S302, the collision simulating module 120 simulates collisions for shaping stations in a product engineering diagram. The collision simulating module 120 determines whether there are collisions, and stores bending tool information created during collision simulated processes in the local database 16. In step S303, the parameter setting module 121 receives determinate parameters of bending sequences for a product engineering diagram, and stores the determinate parameters in the local database 16. The product engineering diagram is prepared in light of simulated collisions. The bending sequences are set according to a product's shape and a preset rule. The rule is: (a) bending sequence from inside to outside; (b) bending size from small to large; (c) first bending a specific shape, then bending a general shape; (d) an earlier bending sequence does not adversely affect a later bending sequence. In step S304, the parameter setting module 121 receives determinate parameters of working procedures, and stores the determinate parameters in the local database 16. The determinate parameters include working procedures, machining attributes, bending angles, bending machines, L values, D values, and so on. When the parameter setting module 121 sets each bending angle, it also sets an arc radius. The arc radius is an inside arc radius at a bend between two plate portions. The above determinate parameters of bending sequences and working procedures are regarded as bending procedure parameters. In step S305, the parameter setting module 121 determines whether the bending procedure parameters are satisfactory; that is, whether the bending procedures meet the design requirements. If the bending procedure parameters do not meet the design requirements, the procedure returns to step S304 described above. If the bending procedure parameters meet the design requirements, in step S306, the manufacturing information card generating module 122 generates manufacturing information cards on bending procedures according to the bending procedure parameters, stores the manufacturing information cards in the local database 16, and prints the manufacturing information cards. In step S307, the tool list generating module 123 generates tool lists according to the bending procedure parameters and bending tools, the bending tools being determined according to the simulated collisions. The tool list generating module stores the tool lists in the production management system database 17. In step S308, the SOP document generating module 124 generates SOP documents for the working procedures. In step S309, the tool manipulation diagram generating module 125 generates tool manipulation diagrams. The tool manipulation diagrams provide guidance for bending machine operators to accurately install and use bending tools. In step S310, the shaping diagram generating module 126 generates shaping diagrams. The shaping diagrams clearly and accurately show information on the product's bending directions and lengths.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A system for formulating and redacting bending procedures used in manufacturing, comprising:
an application server for generating various kinds of bending procedure guidance documents for operations of bending machines, comprising:
a parameter setting module for setting bending procedure parameters, the bending procedure parameters including bending sequences, working procedures, machining attributes, bending angles and bending machines;
a manufacturing information card generating module for generating manufacturing information cards on the bending machines according to the bending procedure parameters;
a tool list generating module for generating tool lists according to the bending procedure parameters;
an SOP (Standard Operating Procedure) document generating module for generating standard guides for the bending machine operations;
a tool manipulation diagram generating module for generating tool manipulation diagrams according to the bending procedure parameters; and
a shaping diagram generating module for generating shaping diagrams according to the bending procedure parameters.

2. The system for formulating and redacting bending procedures used in manufacturing according to claim 1, further comprising a plurality of designing computers and a corporation website, each of the designing computers providing a user interface for setting the bending procedure parameters, the corporation website providing an operation platform for formulating and redacting bending procedures.

3. The system for formulating and redacting bending procedures used in manufacturing according to claim 1, further comprising a local database for storing information used and generated in processes for formulating and redacting bending procedures.

4. The system for formulating and redacting bending procedures used in manufacturing according to claim 1, further comprising a product management system database for storing tool lists and bending tool information.

5. The system for formulating and redacting bending procedures used in manufacturing according to claim 1, wherein the application server further comprises a collision simulating module for anticipating and preventing manufacturing difficulties and providing guidance for accurately and reasonably selecting bending tools.

6. The system for formulating and redacting bending procedures used in manufacturing according to claim 1, wherein the manufacturing information card includes a product's working procedures, bending tools, and assignments of working procedures to various operators.

7. The system for formulating and redacting bending procedures used in manufacturing according to claim 1, wherein the tool list includes bending tools' names, numbers, lengths and quantities.

8. A method for formulating and redacting bending procedures used in manufacturing, comprising the steps of:
setting bending sequences;
setting working procedures including machining attributes, bending angles, and bending machines;
generating one or more manufacturing information cards on the bending machine operations according to the bending sequences and the working procedures;
generating one or more tool lists according to the bending sequences and the working procedures;
generating one or more SOP (Standard Operating Procedure) documents according to the bending sequences and the working procedures;
generating one or more tool manipulation diagrams according to the bending sequences and the working procedures; and
generating one or more shaping diagrams according to the bending sequences and the working procedures.

9. The method for formulating and redacting bending procedures used in manufacturing according to claim 8, further comprising the steps of:
reading documents which describe workpieces;
determining whether there are collisions by way of simulating collisions based on information in the documents; and
determining whether the bending procedures are satisfactory; that is, whether the bending procedures meet design requirements.

10. The method for formulating and redacting bending procedures used in manufacturing according to claim 8, wherein the step of setting bending sequences comprises considering a product's shape and a preset rule, the rule including:
bending sequence from inside to outside;
bending size from small to large;
first bending a specific shape, then bending a general shape; and
an earlier bending sequence does not adversely affect a later bending sequence.

11. The method for formulating and redacting bending procedures used in manufacturing according to claim 8, wherein the tool lists comprise bending tools' names, types, applicable bending machine, and sizing specifications.

12. The method for formulating and redacting bending procedures used in manufacturing according to claim 8, wherein the SOP documents include diagrams relating to bending procedures.

13. A method for formulating and simulating bending procedures used in manufacturing, comprising the steps of:
a. setting bending sequences;
b. setting working procedures;
c. generating one or more tool lists according to the bending sequences and the working procedures;
d. generating one or more tool manipulation diagrams according to the bending sequences and the working procedures; and
e. generating one or more shaping diagrams according to the bending sequences and the working procedures; wherein.
prior to step (a), collision simulation is performed to check whether there are collisions among positions of different bent sections of a whole bent piece.
